(19) United States
(12) Patent Application Publication
(10) Pub. No.: US 2015/0003135 A1
(43) Pub. Date: Jan. 1, 2015

(54) DIRECT CURRENT TO ALTERNATING CURRENT CONVERTER CIRCUIT

(71) Applicant: HON HAI PRECISION INDUSTRY CO., LTD., New Taipei (TW)

(72) Inventors: KAI-FU CHEN, New Taipei (TW); CHIEN-SEN HSU, New Taipei (TW); CHUANG-WEI TSENG, New Taipei (TW); CHE-HSUN CHEN, New Taipei (TW)

(21) Appl. No.: 14/312,970

(22) Filed: Jun. 24, 2014

(30) Foreign Application Priority Data
Jun. 26, 2013 (TW) 102122638

(51) Int. Cl. H02M 7/537

(52) U.S. Cl. CPC H02M 7/537
USPC 363/134

(57) ABSTRACT

A direct current (DC) to alternating current (AC) converter circuit without magnetic components includes a controller, a first DC power supply, a second DC power supply, a first electronic switch, a second electronic switch, a first output terminal, and a second output terminal. The controller controls the first electronic switch and the second electronic switch to turn on and off, to coordinate the outputs of positive and negative voltages from the first output terminal and the second output terminal to present and output an AC voltage. A cycle of the AC is equal to a cycle of a main power supply, and an average of an absolute value of a voltage of the AC is equal to an average of an absolute value of a voltage of the main power supply.

### CROSS-REFERENCE TO RELATED APPLICATIONS

This application claims priority to Taiwanese Patent Application No. 102122638 filed on Jun. 26, 2013 in the Taiwan Intellectual Property Office, the contents of which are incorporated by reference herein.

### FIELD

The subject matter herein generally relates to converter circuits, and particularly to a DC to AC converter circuit for an uninterruptible power supply (UPS).

### BACKGROUND

A UPS supplies emergency power when a main power supply fails. The UPS employs magnetic components, such as an inductor and a transformer, to convert DC to AC.

### BRIEF DESCRIPTION OF THE DRAWING

Implementations of the present technology will be described, by way of example only, with reference to the attached figure, wherein:

FIG. 1 is a circuit diagram of a first embodiment of a direct current (DC) to alternating current (AC) converter circuit comprising a first electronic switch, a second electronic switch, a first output terminal, and a second output terminal.

FIG. 2 is an equivalent circuit diagram of FIG. 1, when the first electronic switch is turned on.

FIG. 3 is an equivalent circuit diagram of FIG. 1, when the second electronic switch is turned on.

FIG. 4 is a waveform graph of a voltage between the first output terminal and the second output terminal of FIG. 1.

FIG. 5 is a waveform graph of a main power supply.

FIG. 6 is a circuit diagram of a second embodiment of a DC to AC converter circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

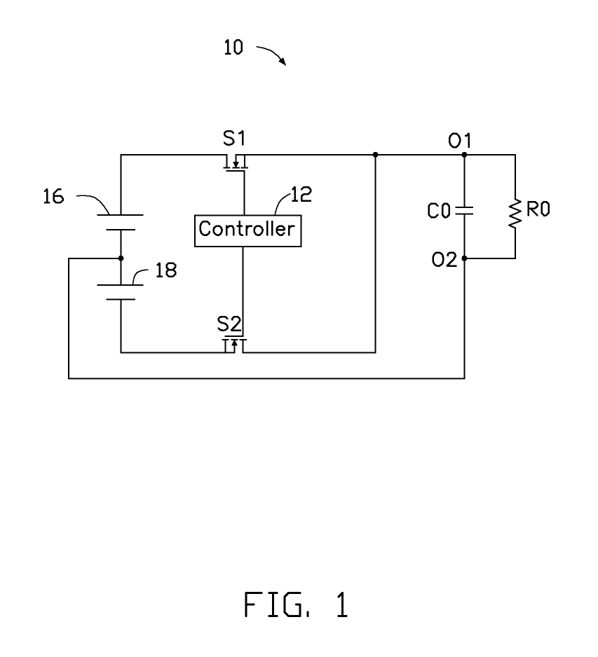

FIG. 1 illustrates a first embodiment of a direct current (DC) to alternating current (AC) converter circuit 10. The DC to AC converter circuit 10 can comprise a controller 12, a first DC power supply 16, a second DC power supply 18, a first electronic switch 51, a second electronic switch S2, a first output terminal O1, a second output terminal O2, and a capacitor C0.

Each of the first electronic switch 51 and the second electronic switch S2 can comprise a first terminal, a second terminal, and a third terminal. The first terminal of the first electronic switch 51 is electrically connected to the controller 12. The second terminal of the first electronic switch 51 is electrically connected to a positive terminal of the first DC power supply 16. The third terminal of the first electronic switch 51 is electrically connected to the first output terminal O1. The first terminal of the second electronic switch S2 is electrically connected to the controller 12. The second terminal of the second electronic switch S2 is electrically connected to the first output terminal O1. The third terminal of the second electronic switch S2 is electrically connected to a negative terminal of the second DC power supply 18. A negative terminal of the first DC power supply 16 is electrically connected to a positive terminal of the second DC power supply 18, and the negative terminal is electrically connected to the second output terminal O2. The capacitor C0 is electrically connected to the first output terminal 01 and the second output terminal O2. A load R0 is electrically connected to the first output terminal O1 and the second output terminal O2. In at least one embodiment, a voltage of the first DC power supply 16 is equal to a voltage of the second DC power supply 18, and each of the first DC power supply 16 and the second DC power supply 18 is a rechargeable battery.

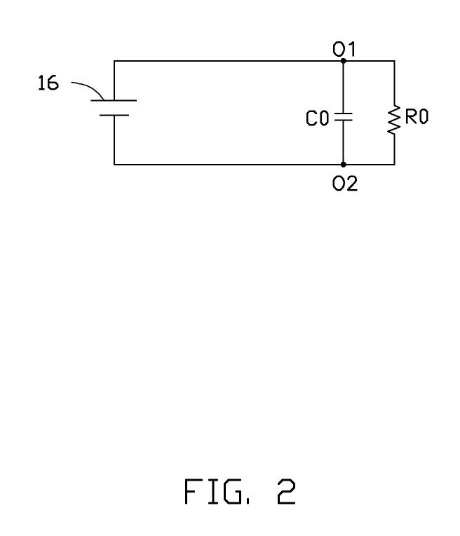

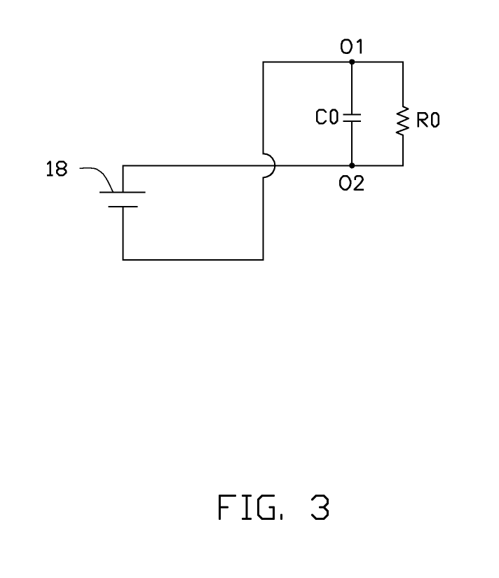

In use, the controller 12 controls the first electronic switch S1 and the second electronic switch S2 to be turned on and turned off, to make the first output terminal O1 and the second output terminal O2 output AC to provide power to the load R0. When the first electronic switch S1 is turned on (see as illustrated as FIG. 2), the load R0 is powered by the first DC power supply 16, and the voltage of the first DC power supply 16 is approximately equal to a voltage of the AC. When the second electronic switch S2 is turned on (see as illustrated as FIG. 3), the load R0 is powered by the second DC power supply 18, and the reverse voltage of the second DC power supply 18 is approximately equal to the voltage of the AC.

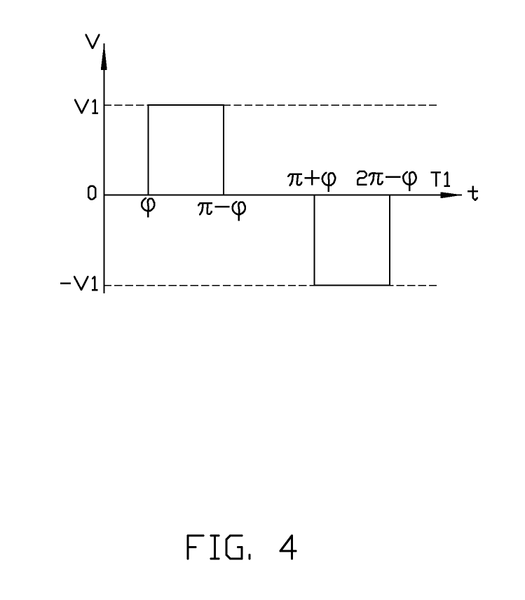

As illustrated in FIG. 4, the controller 12 controls the first electronic switch S1 to be turned on in a phase range of a cycle T1 from about φ to about π−100 , and controls the second electronic switch S2 to be turned on in a phase range of the cycle T1 from about π+φ to about 2π−φ, wherein φ is a phase in which the first electronic switch S1 enters a turned on state. A waveform of the AC is a square wave. An average Vₐᵥₑ₁ of an absolute value of the voltage of the AC in the cycle T1 can be calculated by the following formula (formula 1): Vₐᵥₑ₁=V1(π−2(φ)/π, wherein V1 is the voltage of the DC power supplies 16 and 18, and φ is a phase in which the first electronic switch S1 enters a turned on state.

Similarly, the controller 12 controls the first electronic switch S1 to be turned on in a phase range from about 2kπ+φ to about (2k+1)π−100 , and controls the second electronic switch S2 to be turned on in a phase range from about (2k+1)π+φ to about 2(k+l)π−100 , wherein k is an integer, and φ is the phase in which the first electronic switch S1 enters a turned on state. An average Vₐᵥₑ₂ of an absolute value of the voltage of the AC in each cycle T1 can be calculated by formula 1.

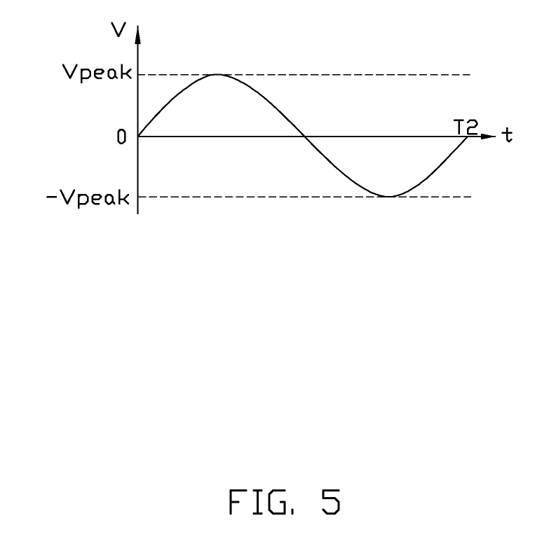

As illustrated in FIG. 5, a waveform of a main power supply (not shown) is a sine wave. An average Vₐᵥₑ₃ of an absolute value of a voltage of the main power supply in a cycle T2 can be calculated by the following formula (formula 2): Vₐᵥₑ₃=2Vpeak/π, wherein Vpeak is a peak voltage of the main power supply. Because the frequency and the peak voltage Vpeak of the main power supply are known, the cycle T2 and the average Vₐᵥₑ₃ can be obtained accordingly.

It may be understood that, the DC to AC converter circuit 10 presents DC of the first DC power supply 16 and the DC of the second power supply 18 together as AC, and outputs the AC to the load R0 through the first output terminal O1 and the second output terminal O2, when the main power supply is not available. Therefore, the cycle T1 should be equal to the cycle T2, and the average Vₐᵥₑ₁ of the absolute value of the voltage of the AC in the cycle T1 should be equal to the average Vₐᵥₑ₃ of the absolute value of the voltage of the main power supply in the cycle T2. That is, T1=T2 and Vₐᵥₑ₁=Vₐᵥₑ₃ (formula 3). According to formulas 1 and 3, the following formula (formula 4) can be obtained: φ=(V1−Vₐᵥₑ₃)π/2V1, wherein V1>Vₐᵥₑ₃, φ is the phase in which the first electronic switch S1 enters the turned on state, V1 is the voltage of the first DC power supply 16 and the second DC power supply 18, and Vₐᵥₑ₃ is the average of an absolute value of a voltage of the main power supply.

In at least one embodiment, each of the first electronic switch S1 and the second electronic switch S2 can be an n-channel metal-oxide semiconductor field-effect transistor (NMOSFET), and the first terminal, the second terminal, and the third terminal of each of the first electronic switch S1 and the second electronic switch S2 respectively correspond to a gate, a drain, and a source of the NMOSFET. In other embodiments, each of the first electronic switch Si and the second electronic switch S2 may be an npn-type bipolar junction transistor or other switch having similar functions.

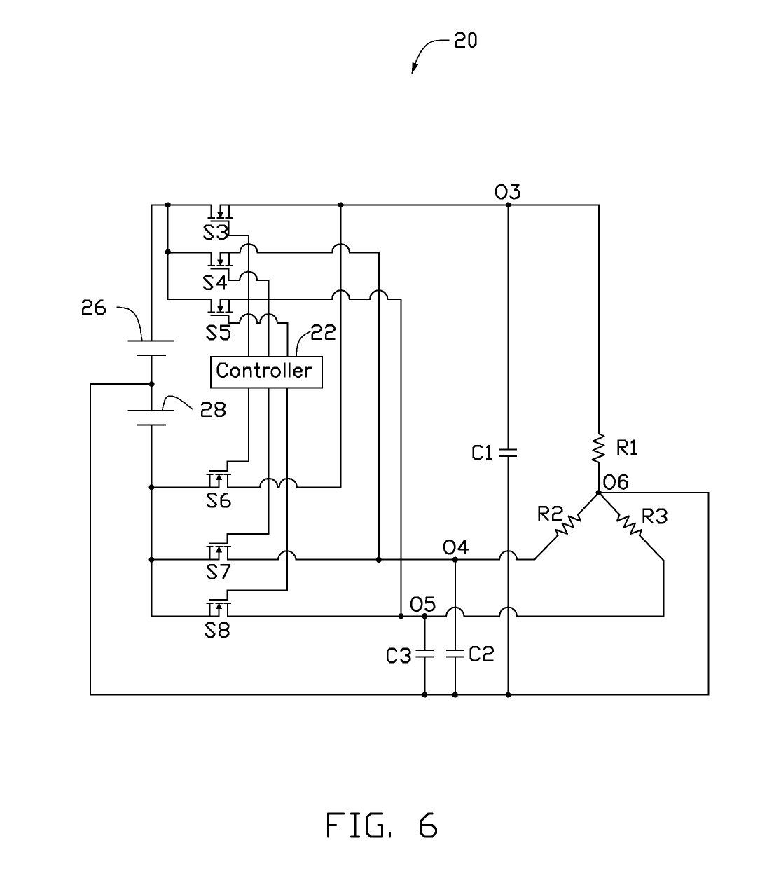

FIG. 6 illustrates a second embodiment of a DC to AC converter circuit 20. The DC to AC converter circuit 20 can comprise a controller 22, a first DC power supply 26, a second DC power supply 28, a first electronic switch S3, a second electronic switch S4, a third electronic switch S5, a fourth electronic switch S6, a fifth electronic switch S7, a sixth electronic switch S8, a first output terminal O3, a second output terminal O4, a third output terminal O5, a fourth output terminal O6, and three capacitors C1-C3.

Each of the first to sixth electronic switches S3-S8 comprises a first terminal, a second terminal, and a third terminal. Each first terminal of the first to sixth electronic switches S3-S8 is electrically connected to the controller 12. Each second terminal of the first to third electronic switches S3-S5 is electrically connected to a positive terminal of the first DC power supply 26. The third terminal of the first electronic switch S3 is electrically connected to the first output terminal O3. The third terminal of the second electronic switch S4 is electrically connected to the second output terminal O4. The third terminal of the third electronic switch S5 is electrically connected to the third output terminal O5. The second terminal of the fourth electronic switch S6 is electrically connected to the first output terminal O3. The second terminal of the fifth electronic switch S7 is electrically connected to the second output terminal O4. The second terminal of the sixth electronic switch S8 is electrically connected to the third output terminal O5. Each third terminal of the fourth to sixth electronic switches S6-S8 is electrically connected to a negative terminal of the second DC power supply 28. A negative terminal of the first DC power supply 26 is electrically connected to a positive terminal of the second DC power supply 28, and is electrically connected to the fourth output terminal O6. The capacitor C1 is electrically connected between the first output terminal O3 and the fourth output terminal O6. A load R1 is electrically connected between the first output terminal O3 and the fourth output terminal O6. The capacitor C2 is electrically connected between the second output terminal O4 and the fourth output terminal O6. A load R2 is electrically connected between the second output terminal O4 and the fourth output terminal O6. The capacitor C3 is electrically connected between the third output terminal O5 and the fourth output terminal O6. A load R3 is electrically connected between the third output terminal O5 and the fourth output terminal O6. In at least one embodiment, a voltage of the first DC power supply 26 is equal to a voltage of the second DC power supply 28, and each of the first DC power supply 26 and the second DC power supply 28 is a rechargeable battery.

In use, the controller 22 controls the first electronic switch S3 and the fourth electronic switch S6 to turn on and turn off, to make the first output terminal O3 and the fourth output terminal O6 output a first phase AC to power the load R1. The controller 22 controls the second electronic switch S4 and the fifth electronic switch S7 to turn on and turn off, to make the second output terminal O4 and the fourth output terminal O6 output a second phase AC to power the load R2. The controller 22 controls the third electronic switch S5 and the sixth electronic switch S8 to turn on and turn off, to make the third output terminal O5 and the fourth output terminal O6 output a third phase AC to power the load R3. A phase difference between the first phase AC and the second phase AC is 2π/3. A phase difference between the second phase AC and the third phase AC is 2π/3. A phase difference between the third phase AC and the first phase AC is 2π/3.

The controller 22 controls the first electronic switch S3 to turn on in a phase range from about 2kπ+φ to about (2k+1)π−100 , and controls the second electronic switch S4 to turn on in a phase range from about (6k+2)π/3+φ to about (6k+5)π/3−φ. The controller 22 controls the third electronic switch S5 to turn on in a phase range from about (6k+4)π/3−φ to about (6k+8)π/3−φ, and controls the fourth electronic switch S6 to turn on in a phase range from about (2k+1)π+φ to about 2(k+1)π−φ. The controller 22 controls the fifth electronic switch S7 to turn on in a phase range from about (6k+5)π/3−φ to about (6k+8)π/3−φ, and controls the sixth electronic switch S8 to turn on in a phase range from about (6k+7)π/3−100 to about (6k+10)π/3−φ, to make each cycle of the first to third phases of AC equal to the cycle of the main power supply. Each average of an absolute value of the voltages of the first to third phases of the AC in each cycle is equal to an average of an absolute value of the voltages of the main power supply in each cycle. φ=(V1−Vₐᵥₑ₃)π/2V1, V1>Vₐᵥₑ₃ , wherein φ is the phase at which the electronic switch S3 enters the turned on state, V1 is the voltage of the DC power supplies 26 and 28, Vₐᵥₑ₃ is the average of the absolute value of the voltages of the main power supply, and K is an integer.

In at least one embodiment, each of the first to sixth electronic switches S3-S8 can be an n-channel metal-oxide semiconductor field-effect transistor (NMOSFET), and the first terminal, the second terminal, and the third terminal of each of the first to sixth electronic switches S3-S8 respectively correspond to a gate, a drain, and a source of the NMOSFET. In other embodiments, each of the first to sixth electronic switches S3-S8 may be an npn-type bipolar junction transistor or other switch having similar functions. The loads R1-R3 may be the same in all cases, and the DC to AC converter circuit 20 outputs a first to third phases of AC to power the load.

As detailed above, the DC to AC converter circuit 10/20 employs the controller 12/22 to control the electronic switches S1-S2/S3-S8 to turn on or turn off, to make the output terminals O1-O2/O3-O6 output AC. Therefore, no magnetic components are needed, and the efficiency of the DC to AC converter circuit 10/20 is high.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure, up to and including the full extent established by the broad general meaning of the terms used in the claims.

What is claimed is:

1. A direct current (DC) to alternating current (AC) converter circuit comprising:
a controller;
a first DC power supply comprising a positive terminal and a negative terminal;
a second DC power supply comprising a positive terminal electrically connected to the negative terminal of the first DC power supply, and a negative terminal;
a first output terminal;
a second output terminal electrically connected to the negative terminal of the first DC power supply;
a first electronic switch comprising a first terminal electrically connected to the controller, a second terminal electrically connected to the positive terminal of the first DC power supply, and a third terminal electrically connected to the first output terminal; and
a second electronic switch comprising a first terminal electrically connected to the controller, a second terminal electrically connected to the first output terminal, and a third terminal electrically connected to the negative terminal of the second DC power supply;
wherein the controller controls the first electronic switch and the second electronic switch to be turned on and turned off, to make the first output terminal and the second output terminal output AC, a cycle of the AC is equal to a cycle of a main power supply, and an average of an absolute value of a voltage of the AC is equal to an average of an absolute value of a voltage of the main power supply.

2. The DC to AC converter circuit of claim 1, wherein a voltage of the first DC power supply is equal to a voltage of the second DC power supply, the controller controls the first electronic switch to be turned on in a phase range from about 2kπ+φ to about (2k+1)π−φ, and controls the second electronic switch to be turned on in a phase range from about (2k+1)π+φ to about 2(k+1)π−φ, wherein φ=(V1−Vₐᵥₑ₃)π/2V1, V1>Vₐᵥₑ₃, φ is a phase at which the first electronic switch enters a turned on state, V1 is the voltage of the first DC power supply and the second DC power supply, Vₐᵥₑ₃ is the average of the absolute value of the voltage of the main power supply, and K is an integer.

3. The DC to AC converter circuit of claim 1, wherein each of the first electronic switch and the second electronic switch is an n-channel metal-oxide semiconductor field-effect transistor (NMOSFET), and the first terminal, the second terminal, and the third terminal of each of the first electronic switch and the second electronic switch are respectively corresponding to a gate, a drain, and a source of the NMOSFET.

4. A direct current (DC) to alternating current (AC) converter circuit comprising:
a controller;
a first DC power supply comprising a positive terminal and a negative terminal;
a second DC power supply comprising a positive terminal electrically connected to the negative terminal of the first DC power supply, and a negative terminal;
a first output terminal;
a second output terminal;
a third output terminal;
a fourth output terminal electrically connected to the negative terminal of the first DC power supply;
a first electronic switch comprising a first terminal electrically connected to the controller, a second terminal electrically connected to the positive terminal of the first DC power supply, and a third terminal electrically connected to the first output terminal;
a second electronic switch comprising a first terminal electrically connected to the controller, a second terminal electrically connected to the positive terminal of the first DC power supply, and a third terminal electrically connected to the second output terminal;
a third electronic switch comprising a first terminal electrically connected to the controller, a second terminal electrically connected to the positive terminal of the first DC power supply, and a third terminal electrically connected to the third output terminal;
a fourth electronic switch comprising a first terminal electrically connected to the controller, a second terminal electrically connected to the first output terminal, and a third terminal electrically connected to the negative terminal of the second DC power supply;
a fifth electronic switch comprising a first terminal electrically connected to the controller, a second terminal electrically connected to the second output terminal, and a third terminal electrically connected to the negative terminal of the second DC power supply; and
a sixth electronic switch comprising a first terminal electrically connected to the controller, a second terminal electrically connected to the third output terminal, and a third terminal electrically connected to the negative terminal of the second DC power supply;
wherein the controller controls the first to sixth electronic switches to be turned on and turned off, to make the first output terminal and the fourth output terminal output a first phase AC, the second output terminal and the fourth output terminal output a second phase AC, and the third output terminal and the fourth output terminal output a third phase AC, a cycle of each of the first phase AC, the second phase AC, and the third phase AC is equal to a cycle of a main power supply, an average of an absolute value of a voltage of each of the first phase AC, the second phase AC, and the third phase AC is equal to an average of an absolute value of a voltage of the main power supply, a phase difference between the first phase AC and the second phase AC is 2π/3, a phase difference between the second phase AC and the third phase AC is 2π/3, and a phase difference between the third phase AC and the first phase AC is 2π/3.

5. The DC to AC converter circuit of claim 4, wherein a voltage of the first DC power supply is equal to a voltage of the second DC power supply, the controller controls the first electronic switch to be turned on in a phase range from about 2kπ+φ to about (2k+1)π−φ, controls the second electronic switch to be turned on in a phase range from about (6k+2)π/3+φ to about (6k+5)π/3−φ, controls the third electronic switch to be turned on in a phase range from about (6k+4)π/3+φ to about (6k+8)π/3−φ, controls the fourth electronic switch to be turned on in a phase range from about (2k+1)π+φ to about 2(k+1)π−φ, controls the fifth electronic switch to be turned on in a phase range from about (6k+5)π/3+φ to about (6k+8)π/3−φ, and controls the sixth electronic switch to be turned on in a phase range from about (6k+7)π/3+φ to about (6k+10)π/3−φ, wherein φ=(V1−Vₐᵥₑ₃)π/2V1, V1>Vₐᵥₑ₃, φ is a phase at which the first electronic switch enters a turned on state, V1 is the voltage of the first DC power supply and the second DC power supply, Vₐᵥₑ₃ is the average of the absolute value of the voltage of the main power supply, and K is an integer.

6. The DC to AC converter circuit of claim 4, wherein each of the first to sixth electronic switches is an n-channel metal-oxide semiconductor field-effect transistor (NMOSFET), and the first terminal, the second terminal, and the third terminal of each of the first to sixth electronic switches are respectively corresponding to a gate, a drain, and a source of the NMOSFET.
